(19) United States
(12) Patent Application Publication
(10) Pub. No.: US 2016/0269242 A1
(43) Pub. Date: Sep. 15, 2016

(54) IMPROVED SUBNET PROVISIONING METHOD

(71) Applicant: THOMSON LICENSING, Issy les Moulineaux (FR)

(72) Inventor: Casimir Johan CRAWLEY, Carmel, IN (US)

(73) Assignee: Thomson Licensing, Issy les Moulineaux (FR)

(21) Appl. No.: 15/030,305

(22) PCT Filed: Oct. 25, 2013
(86) PCT No.: PCT/US2013/066754

§ 371 Date: Apr. 18, 2016

(51) Int. Cl. H04L 12/24; H04L 29/12; H04L 29/08

(52) U.S. Cl. CPC H04L 41/0863; H04L 41/0266; H04L 41/0866; H04L 67/02; H04L 61/6068

(57) ABSTRACT

A method for disabling subnet settings is described including parsing a configuration file, determining if an extensible markup language predefined internet protocol address element is present in the configuration file, determining if predefined internet protocol address elements are present in the configuration file, determining if predefined default extensible markup language address elements are present in the configuration file, restoring default subnet setting, if predefined internet protocol address elements are not present in the configuration file or if predefined internet protocol address elements are present in the configuration file and predefined extensible markup language address elements are present in the configuration file.

### FIELD OF THE INVENTION

The present invention relates to network provisioning and, in particular, to automated provisioning.

### BACKGROUND OF THE INVENTION

Some content providers currently provision routed or bridged subnets by downloading an Extensible Markup Language (XML) configuration file and performing additional manual steps. The manual steps are accomplished using a command line interface (CLI) or web graphical user interface (GUI). Disabling routed or bridged subnets requires additional CLI, web GUI or factory equipment reset steps since content provider's XML structure does not sufficiently define routed or bridged subnet default settings.

### SUMMARY OF THE INVENTION

The present invention disables routed or bridged subnet settings using the content provider's XML structure thus avoiding additional CLI and/or GUI steps or losing customized settings resulting from an equipment factory reset operation. The present invention is implemented in a gateway cable router.

A method and apparatus for disabling subnet settings is described including parsing a configuration file, determining if an extensible markup language predefined internet protocol address element is present in the configuration file, determining if predefined internet protocol address elements are present in the configuration file, determining if predefined default extensible markup language address elements are present in the configuration file, restoring default subnet setting, if predefined internet protocol address elements are not present in the configuration file or if predefined internet protocol address elements are present in the configuration file and predefined extensible markup language address elements are present in the configuration file.

### BRIEF DESCRIPTION OF THE DRAWINGS

The present invention is best understood from the following detailed description when read in conjunction with the accompanying drawings. The drawings include the following figures briefly described below:

FIG. 1 is a flowchart of an exemplary embodiment of the present invention.

FIG. 2 shows the content provider's XML default IP address present test code.

FIG. 3 is a block diagram of an exemplary embodiment in accordance with the principles of the present invention.

### DETAILED DESCRIPTION OF THE PREFERRED EMBODIMENTS

The present invention disables routed or bridged subnet settings exclusively using the content provider's XML structure thus avoiding additional CLI and/or GUI steps or losing customized settings resulting from an equipment factory reset operation.

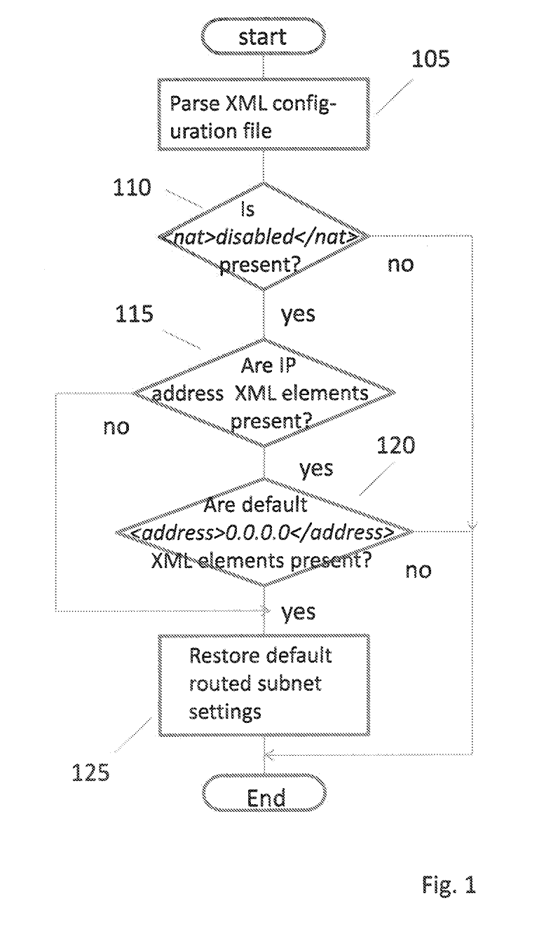

Referring to FIG. 1, which is a flowchart of an exemplary embodiment of the present invention, at 105 the content provider's configuration file is parsed. At 110, a test is performed to determine if the XML element <nat>disabled</nat> is present in the configuration file. If the XML element <nat>disabled</nat> is present in the configuration file then at 115 a test is performed to determine if IP address XML elements are present in the configuration file. If IP address XML elements are present in the configuration file then at 120 a test is performed to determine if default <address>0.0.0.0</address> XML elements are present in the configuration file. If default <address>0.0.0.0</address> XML elements are present in the configuration file then at 125 the default routed or bridged subnet settings are restored. If default <address>0.0.0.0</address> XML elements are not present in the configuration file processing ends. If IP address XML elements are not present in the configuration file then processing proceeds to 125. If the XML element <nat>disabled</nat> is not present in the configuration file the processing ends. The XML element <nat>disabled</nat> is content provider's IP address element.

An example of an actual IP address element is:

```
<ip ipVersion=“4”>
  <address>192.168.0.1<address>
  <netmask>255.255.255.0</netmask>
</ip>
```

Exemplary code for step 115 to determine if default IP address elements are present would include a test to determine if the configuration contains no <ip> . . . </ip> elements.

An exemplary case configuring routed or bridged subnets is as follows:

```
<nat>disabled</nat>
<ip ipVersion=“4”>
  <address>157.254.37.78</address>
  <netmask>255.255.240.0</netmask>
</ip>
```

Below are the two exemplary cases restoring default routed or bridged subnet settings:

1. Configuration file contains no IP address elements:
<nat>disabled</nat>

2. Configuration file contains IP address elements:
<nat>disabled</nat>
<ip ipVersion=“4”>
   <address>0.0.0.0</address>
</ip>
   Case 1 lacks <ip>. . . </ip> address elements configuring routed or bridged subnets whereas Case 2 restores default settings using <ip><address>0.0.0.0</address></ip>. Case 1 and Case 2 implicitly and explicitly restore default settings respectively.

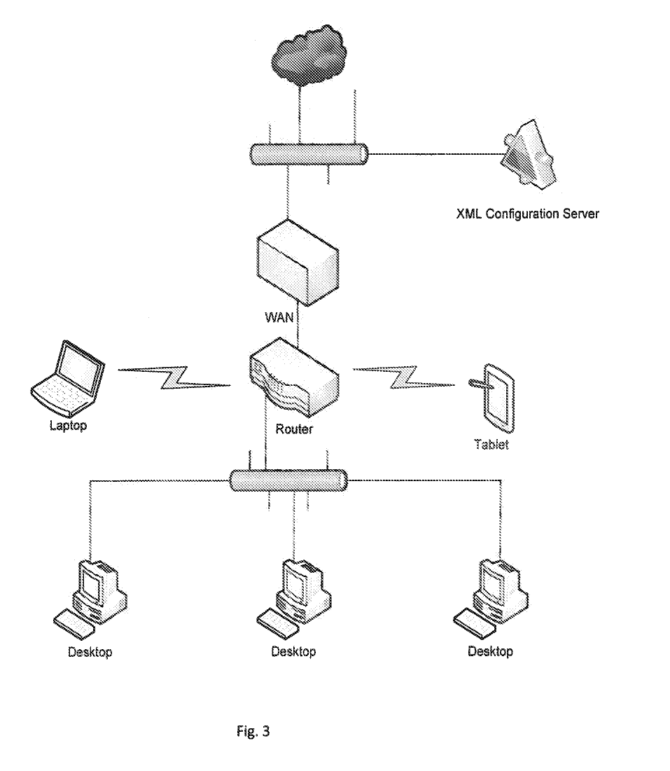

The present invention may be implemented in a gateway router as shown on FIG. 3 described below or in a digital subscriber Line (DSL) or a Gigabit Passive Optical network (GPON) such as Verizon's FIOS®. A gateway router may be a gateway cable router.

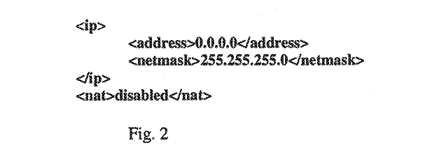

FIG. 2 shows the content provider's XML default IP address element present test. “0.0.0.0. ” is the disable setting defined by the equipment manufacturer. The equipment manufacturer reads these settings when disabling IEEE 802.11 Guest Network subnets. The content provider specifies these settings when disabling Guest Network subnets

Exemplary code to implement the restore default router settings (respectively case 1 and case 2 from above) portions of the logic above is as follows:

```
if (fAddress.empty( ) == true)
{
  /*
    bIsDefault defaults true and supports XML Configurator default “Route
    Settings” currently unsupported by any MIB. If an XML Configurator
    file's “<logicalInterface>” empties “<ip>” while disabling both “<nat>”
    and “<dhcpServer>”, then bIsDefault is true and XmlIp::AddDefaults( )
    provides the default “Route Network Ip”, “Route Subnet Mask”, and
    “Route Gateway Mask” settings that XmlIp::DisableGuestNetworkNat( )
    uses while clearing both “Routing Enabled” and “Dhcp Routing Subnet
    Enabled”. If an XML Configurator file's “<logicalInterface>” provides
    “<ip>” default settings while disabling both “<nat>” and
    “<dhcpServer>”, then bIsDefault is false and the XML Configurator file
    provides the default settings that XmlIp::DisableGuestNetworkNat( )
    uses while clearing “Routing Enabled” and “Dhcp Routing Subnet
    Enabled”.
  */
  // restore default routed or bridged subnet settings
  bIsDefault = true;
  if (fPhyInt & (ethernetPhysicalInterface | usbPhysicalInterface |
      mocaPhysicalInterface | ssid0PhysicalInterface))
  {
    // default DHCP server routed or bridged subnet settings
    fAddress = kDefaultValue_CdsServerDhcpAddress;
  }
  else if (fPhyInt & ssid1PhysicalInterface)
  {
    // default Guest Network 0 routed or bridged subnet settings
    fAddress = kDefaultValue_WiFi80211GuestNetworkDhcpIpAddress_0;
  }
  else if (fPhyInt & ssid2PhysicalInterface)
  {
    // default Guest Network 1 routed or bridged subnet settings
    fAddress = kDefaultValue_WiFi80211GuestNetworkDhcpIpAddress_1;
  }
  else
  {
    // default Guest Network 2 routed or bridged subnet settings
    fAddress = kDefaultValue_WiFi80211GuestNetworkDhcpIpAddress_2;
  }
}
/*
  bIsDefault defaults true and supports XML Configurator default “Route
  Settings” currently unsupported by any MIB. If an XML Configurator
  file's “<logicalInterface>” empties “<ip>” while disabling both “<nat>”
  and “<dhcpServer>”, then bIsDefault is true and XmlIp::AddDefaults( )
  provides the default “Route Network Ip”, “Route Subnet Mask”, and “Route
  Gateway Mask” settings while both “Routing Enabled” and “Dhcp Routing
Subnet Enabled” are cleared. If an XML Configurator file's
  “<logicalInterface>” provides “<ip>” default settings while disabling
  both “<nat>” and “<dhcpServer>”, then bIsDefault is false and the XML
  Configurator file provides default settings while both “Routing Enabled”
  and “Dhcp Routing Subnet Enabled” are cleared.
*/
if (nwIpAddr == kAllZerosIp || bIsDefault == true)
{
  /// restore default Routed or bridged Subnet Settings
  nwIpAddr = kAllZerosIp;
  gwIpAddr = nwIpAddr;
  ipMask = kCableHomePrivateLanSubnetMask;
  pRgNonVol->SetFeatureDisable((RgFeatures) kRgRoutingEnablecl);
  pRgNonVol->SetFeatureDisable((RgFeatures) kRgDhcpRoutedSubnet);
  pRgNonVol->NatRoutedSubnetGatewayIpAddress(gwIpAddr);
} // if ((fAddress...
pRgNonVol->RipRoutedSubnetNetworkIpAddress(nwIpAddr,index);
pRgNonVol->RipRoutedSubnetMaskIpAddress(ipMask,index);
pRgNonVol->RipRoutedSubnetGatewayIpAddress(gwIpAddr,index);
```

FIG. 3 is a block diagram of an exemplary embodiment in accordance with the principles of the present invention. A residential (home) or business network may include a plurality of devices including desktop computers, laptop computers and tablets. The devices may be wireless or wired line. And are in bidirectional communication with a gateway router (indicated simply as “router” on FIG. 3) provided by the service provider or content provider. The gateway cable router is in bidirectional communication with a Wide Area Network (WAN), which is in bidirectional communication with the XML Configuration Server of the service provider or content provider. The XML Configuration Server is a server providing the XML Configurator file (or XML Configuration file). The devices of the residential or business network may access the internet via gateway router, the WAN and the cloud. If an error occurs in the gateway cable router and the default router setting must be restored the present invention supports doing so without the necessity of manual administrator intervention.

As indicated above, the present invention may be implemented in a gateway router, a DSL, a GPON or a variety of other equivalent devices. The gateway router or equivalent device having the processing means therein for executing the XML Configurator (Configuration) file. An apparatus for disabling routed or bridged subnet settings is described including means for parsing a configuration file, means for determining if an extensible markup language predefined internet protocol address element is present in the configuration file, means for determining if predefined internet protocol address elements are present in the configuration file, means for determining if predefined default extensible markup language address elements are present in the configuration file, means for restoring default routed or bridged subnet setting, if predefined internet protocol address elements are not present in the configuration file or if predefined internet protocol address elements are present in the configuration file and predefined extensible markup language address elements are present in the configuration file.

It is to be understood that the present invention may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for disabling subnet settings, said method comprising:
parsing a configuration file;
determining if an extensible markup language predefined internet protocol address element is present in said configuration file;
determining if predefined internet protocol address elements are present in said configuration file;
determining if predefined default extensible markup language address elements are present in said configuration file;
restoring default subnet setting, if predefined internet protocol address elements are not present in said configuration file or if predefined internet protocol address elements are present in said configuration file and predefined extensible markup language address elements are present in said configuration file.

2. The method according to claim 1, wherein said extensible markup language predefined internet protocol address element is nat>disabled</nat>.

3. The method according to claim 1, wherein predefined default extensible markup language address elements are of the form <address>0.0.0.0</address>.

4. The method according to claim 1, wherein said configuration file is an XML configuration file.

5. The method according to claim 1, wherein said subnet is routed or bridged.

6. An apparatus for disabling subnet settings, comprising:
means for a processor, parsing a configuration file;
said processor determining if an extensible markup language predefined internet protocol address element is present in said configuration file;
said processor determining if predefined internet protocol address elements are present in said configuration file;
said processor determining if predefined default extensible markup language address elements are present in said configuration file;
said processor restoring default subnet setting, if predefined internet protocol address elements are not present in said configuration file or if predefined internet protocol address elements are present in said configuration file and predefined extensible markup language address elements are present in said configuration file.

7. The apparatus according to claim 6, wherein said extensible markup language predefined internet protocol address element is nat>disabled</nat>.

8. The apparatus according to claim 6, wherein predefined default extensible markup language address elements are of the form <address>0.0.0.0</address>.

9. The apparatus according to claim 6, wherein said apparatus is a gateway router.

10. The apparatus according to claim 6, wherein said configuration file is an XML configuration file.

11. The apparatus according to claim 6, wherein said subnet is routed or bridged.
